(19) United States
(12) Patent Application Publication
(10) Pub. No.: US 2009/0020510 A1
(43) Pub. Date: Jan. 22, 2009

(54) Method for electric arc joining

(76) Inventors: Eberhard Brune, Wolfenschiessen (CH); Hans Grollimund, Reinach (CH); Thomas Ammann, Munich (DE)

Correspondence Address: The BOC Group, Inc., 575 MOUNTAIN AVENUE, MURRAY HILL, NJ, 07974-2082, US

(21) Appl. No.: 12/157,838

(22) Filed: Jun. 13, 2008

(30) Foreign Application Priority Data
Jul. 17, 2007 (DE) 102007033291.4
Oct. 18, 2007 (EP) 07020456.5

(51) Int. Cl. B23K 9/16

(52) U.S. Cl. 219/74

(57) ABSTRACT

A method for electric arc joining, in particular for arc welding and/or arc soldering, under protective gas using the method of T[ungsten] l[nert] G[as] joining, in particular TIG welding and/or TIG soldering, at least one gas mixture having the composition essentially argon and/or helium and carbon dioxide in a proportion range from approximately 0.2 volume-percent (vol.-%) to approximately 0.7 vol.-% being supplied as the protective gas, as well as a corresponding protective gas, in such a manner that weld pool movements, electric arc turbulence, and occurrences of wear of the T[ungsten] l[nert] G[as] electrode may be reliably avoided. The protective gas also has hydrogen in a proportion range from approximately 1.8 vol.-% to approximately 9 vol.-%.

### CROSS REFERENCE TO RELATED APPLICATIONS

This application claims priority from German Patent Application Serial No.102007033291.4, filed Jul. 17, 2007, and European Patent Application No. 07020456.5, filed Oct. 18, 2007.

### BACKGROUND OF THE INVENTION

The present invention relates to methods for electric arc joining such as arc welding and arc soldering using a protective gas mixture comprising argon and/or helium, carbon dioxide and hydrogen.

Electric arc joining under protective gas is a frequently used joining technology which particularly comprises arc welding and arc soldering. Furthermore, electric arc joining also includes the bonding of materials of different types, one material being fused, while the other material is only heated.

In arc welding, an electric arc burns between an electrode situated in a burner and the workpiece to be processed. A weld bond arises here through fusion of the base material at the processing point in the electric arc and subsequent re-solidification of the material.

Various welding methods are used for arc welding under protective gas, so-called M[etal] P[rotective] G[as] welding: in addition to the methods having meltable electrodes, which include M[etal] A[ctive] G[as] welding and M[etal] l[nert] G[as] welding, T[ungsten] l[nert] G[as] welding and plasma welding, which operate using non-meltable electrodes, exist.

The welding behavior may be influenced by a suitable protective gas selection. In T[ungsten] l[nert] G[as] welding or TIG welding, inert or very weakly active gases or gas mixtures are typically used as the protective gas. Protective gases which are suitable for TIG welding are described, for example, in the publication EP 0 544 187 A1, in the publication EP 1 607 168 A1, or in the publication EP 0 639 427 A1, EP 0 639 427 A1 containing a method for protective gas welding (TIG or MIG/MAG), in which a protective gas mixture made of 0.005 to 0.1 vol.-% carbon dioxide and/or oxygen, 0.5 to 4 vol.-% hydrogen, and 10 to 55 vol.-% helium and preferably at least 40 vol.-% argon is used.

A protective gas for TIG welding made of argon, helium, and hydrogen, which causes advantageous flow behavior, is described in the publications DE 102 54 743 A1 and EP 1 295 669 A1. The protective gas disclosed in DE 102 54 743 A1 from this reference has
9 vol.-% to 30 vol.-% helium,
0.15 vol.-% to 5 vol.-% hydrogen, and
argon in the remaining volume proportion; the protective gas disclosed in the publication EP 1 295 669 Al has
5 vol.-% to 60 vol.-% helium,
0.1 vol.-% to 10 vol.-% hydrogen, and
argon in the remaining volume proportion.

In TIG welding in industrial manufacturing, different types of materials are frequently to be bonded to one another. An example of this are pipe-flange bonds, in which the pipe comprises normal, non-rusting steel and the flange comprises a so-called machining steel.

Machining steels are steels which are optimized for machining, for example, for turning, milling, or drilling, on automated machine tools. This improved machining ability is achieved by an alloy having approximately 0.25 vol.-% sulfur, for example. Brittle inclusions at which the chips may break form due to the addition of sulfur, possibly in addition to further alloy elements. This does improve the machining ability, but the suitability for welding suffers significantly.

Thus, as a result of the so-called Marangoni effect or the so-called Marangoni convection, i.e., a partial flow reversal in the weld pool caused by the sulfur content, upon joining of machining steel with normal steel, worsening of the flow behavior, in particular very disadvantageous weld pool movements, and strong electric arc turbulence arise. The Marangoni effect may also occur in the bonding of materials which are actually identical, but display deviating welding behavior as a result of differing batch composition.

It is known from the article “Marangoni Convection in Weld Pool in CO₂—Ar-Shielded Gas Thermal Arc Welding” by Shanping Lu, Hidetoshi Fujii, and Kiyoshi Nogi, published in “Metallurgical and Materials Transactions A”, Volume 35A, September 2004, pages 2861 through 2867, that the problems described above of the weld pool movement and the electric arc turbulence may be solved by admixing approximately 0.5% carbon dioxide (CO₂) to the protective gas argon (Ar). This article describes a method and a protective gas of the type cited at the beginning.

The weld pool movement and the weld pool flow are influenced by the CO₂ admixture in such a manner that in spite of differing material composition, a uniform flow behavior results. According to the literature and some independent experiments of the inventor, the optimum for the CO₂ content of the protective gas is approximately 0.5%.

However, such a quantity of carbon dioxide is already very harmful for the T[ungsten] l[nert] G[as] electrode, which shows significant signs of worsening after even a very short time.

It is known from publication DE 24 51 591 A1 that oxide formation and signs of wear of the electrodes accompanying it may be avoided by adding 0.1 vol.-% to 1 vol.-% hydrogen to a protective gas made of argon and/or helium. Furthermore, publication EP 0 826 456 A1 discloses a protective gas mixture made of argon, which has 2 vol.-% to 3.7 vol.-% nitrogen to reduce the susceptibility to corrosion of the weld seam and 0.5 vol.-% to 1.2 vol.-% hydrogen to avoid rapid wear of the electrode. However, it is also known from the publication DE 24 51 591 A1 that the hydrogen content of the protective gas may not be very high, so that the welding quality is not impaired.

Proceeding from the disadvantages and impossibilities described above and taking the outlined prior art into consideration, the present invention is based on the object of refining a method of the type cited at the beginning and the use of at least one protective gas of the type cited at the beginning in such a manner that weld pool movements, electric arc turbulence, and signs of wear of the T[ungsten] l[nert] G[as] electrode may be reliably avoided.

### SUMMARY OF THE INVENTION

This object is achieved by a method having the features a method for electric arc joining, in particular for arc welding and/or arc soldering, under protective gas using the method of T[ungsten] l[nert] G[as] joining, in particular TIG welding and/or TIG soldering, at least one gas mixture comprising
essentially argon and/or helium and
carbon dioxide in a proportion range from approximately 0.2 volume percent (vol.-%) to approximately 0.7 vol.-%

being supplied as the protective gas, characterized in that the protective gas also has hydrogen in a proportion range from approximately 1.8 vol.-% to approximately 9 vol.-% and by the use of at least one protective gas. This protective gas for electric arc joining, in particular for arc welding and/or for arc soldering, using the method of T[ungsten] l[nert] G[as] joining, in particular TIG welding and/or TIG soldering, wherein the protective gas comprises
essentially argon and/or helium,
carbon dioxide in a proportion range from approximately 0.2 volume-percent (vol.-%) to approximately 0.7 vol.-%, and
hydrogen in a proportion range from approximately 1.8 vol.-% to approximately 9 vol.-%.

Advantageous embodiments and expedient refinements of the present invention are characterized further below.

### DETAILED DESCRIPTION OF THE INVENTION

The present invention is thus based on an active gas mixture, in particular an active protective gas mixture, for T[ungsten] l[nert] G[as] welding; the protective gas thus has hydrogen (H₂), in particular additional hydrogen is admixed to the protective gas. The hydrogen ensures favorable fusion behavior on one hand; the hydrogen protects the electrode from the influence of the carbon dioxide due to its reducing action on the other hand.

It was established in a manner surprising to one skilled in the art that the protective gas may also have a comparatively high hydrogen content because of a relatively high carbon dioxide content, the welding quality not being negatively influenced, but rather even improved.

It was thus established that at
a carbon dioxide content in a proportion range of approximately 0.2 volume-percent (vol.-%) to approximately 0.7 vol.-% and
a hydrogen content in a proportion range from approximately 1.8 vol.-% to approximately 9 vol.-%

surprisingly not only is the wear of the electrode significantly reduced, i.e., the electrode lasts longer, but rather fewer pores occur upon joining, the flow behavior is improved, and a higher joining speed is achieved.

Surprisingly, it has thus been shown that the activity of the carbon dioxide described in article cited in above discussion of the references, “Marangoni Convection in Weld Pool in CO₂—Ar-Shielded Gas Thermal Arc Welding”, in regard to the stabilization of the electric arc and in regard to the improvement of the flow behavior, in particular in regard to avoiding the weld pool movement, is not reduced, but rather even supported by a hydrogen content in the protective gas of approximately 1.8 vol.-% approximately 9 vol.-%.

Furthermore, the observation that in the method according to the invention, in which the protective gas has a combination made of approximately 0.2 vol.-% to approximately 0.7 vol.-% carbon dioxide with approximately 1.8 vol.-% to approximately 9 vol.-% hydrogen, the electric arc stability is significantly improved, i.e., the electric arc is very calm, is especially surprising.

Further advantages of the present invention are a reduction of the oxidation of the seam surface and especially uniform seam descaling.

The protective gas advantageously has hydrogen in a range from approximately 4.5 vol.-% to approximately 8 vol.-%, in particular at a proportion of approximately 5 vol.-% to approximately 7 vol.-%, for example, approximately 6 vol.-%.

The content of argon may be approximately 30 vol.-% to approximately 95 vol.-%, in particular approximately 40 vol.-% to approximately 50 vol.-%.

Furthermore, according to a further advantageous embodiment of the present invention, helium may be admixed to the protective gas in a range from approximately 10 vol.-% to approximately 70 vol.-%, in particular at a proportion of approximately 20 vol.-% to approximately 50 vol.-%, for example, approximately 25 vol.-% to approximately 30 vol.-%.

An especially preferred embodiment of the protective gas comprises
approximately 0.2 vol.-% to approximately 0.7 vol.-% carbon dioxide, in particular approximately 0.5 vol.-% to approximately 0.6 vol.-% carbon dioxide,
approximately 4.5 vol.-% to approximately 8 vol.-% hydrogen, in particular approximately 5 vol.-% to approximately 7 vol.-% hydrogen, for example, approximately 6 vol.-% hydrogen, and
argon and/or helium in the remaining proportion range.

The protective gas may be mixed from two or more starting gases or starting gas mixtures at the location of use. However, it is also possible for the protective gas to be provided and/or sold as a finished mixture.

The present invention offers the advantage that unlike bonds may be joined, in particular welded, without restrictions in regard to fusion and/or in regard to electric arc calmness without problems. The strong electrode wear to be expected here per se largely does not occur due to the hydrogen admixture.

The protective gas according to the type described above is especially advantageously employed in electric arc joining, in particular in arc welding and/or arc soldering, of at least one object to be joined
made of different materials, in particular made of sulfur-free steel and sulfur-containing steel, for example, a pipe-flange bond, and/or made of material of different batches,

using the method according to the type described above.

Using the method according to the type described above, at least one material bond of different types of material may thus be provided having surprisingly good quality.

In particular, at least one object made of at least two different materials may be joined.

Furthermore, at least one object made of at least two different types of material, for example,
unalloyed and low-alloy steel or
unalloyed and high-alloy steel or
low-alloy and high-alloy steel or
steel (unalloyed, low-alloy, or high-alloy) and a nickel-based material,

may be joined. In particular, duplex steels and nickel-based materials may be bonded to one another or also rusting with non-rusting steels or also differently alloyed construction steels, for example.

However, the object to be joined may also comprise at least two different classes of material, in particular different high-alloy steels. Thus, for example, high-alloy sulfur-containing steel may be bonded to high-alloy sulfur-free steel. For example, high-alloy molybdenum-containing steel may also be bonded to high-alloy molybdenum-free steel or a duplex steel to a chromium-nickel steel. In practice, the bond may be a pipe-flange bond, for example. In a bond made of different classes of material, various high-alloy steels are preferably bonded, however, other classes of steel or in particular also different nickel-based materials may also be bonded to one another.

Furthermore, the present invention is usable especially advantageously in joining at least one object made of at least one material from different batches. Batch differences occur because of the tolerances which standards permit for identical materials and which are exploited in production.

The present invention particularly relates to both manually-controlled or manual and also automated or mechanical T[ungsten] l[nert] G[as] welding of differing or unlike bonds or materials of all types, for example, also of non-rusting steel to non-rusting machining steel, or of identical or similar bonds or materials belonging to different batches.

We claim:

1. A method for electric arc joining under protective gas using the method of Tungsten Inert Gas joining at least one gas mixture comprising argon and/or helium and carbon dioxide in a proportion range from approximately 0.2 vol.-% to approximately 0.7 vol.-% being supplied as the protective gas, characterized in that, the protective gas contains hydrogen in a proportion range from approximately 1.8 vol.-% to approximately 9 vol.-%.

2. The method according to claim 1 wherein said electric arc joining is selected from the group consisting of arc welding and arc soldering.

3. The method according to claim 1 wherein said tungsten inert gas joining is selected from the group consisting of tungsten inert gas welding and tungsten inert gas soldering.

4. The method according to claim 1, characterized in that the protective gas has hydrogen in a proportion range from approximately 4.5 vol.-% to approximately 8 vol.-%.

5. The method according to claim 4 wherein said proportion range of hydrogen in said protective gas is approximately 5 vol.-% to approximately 7 vol.-%.

6. The method according to claim 4 wherein said proportion range of hydrogen in said protective gas is approximately 6 vol.-%.

7. The method according to claim 1, characterized in that the protective gas has argon in a proportion range from approximately 30 vol.-% to approximately 95 vol.-% and/or helium in a proportion range from approximately 10 vol.-% to approximately 70 vol.-%.

8. The method according to claim 7 wherein said proportion range of argon in said protective gas is approximately 40 vol.-% to approximately 50 vol.-%.

9. The method according to claim 7 wherein said proportion range of helium in said protective gas is approximately 20 vol.-% to approximately 50 vol.-%.

10. The method according to claim 7 wherein said proportion range of helium in said protective gas is approximately 25 vol.-% to approximately 30 vol.-%.

11. The method according to claim 1, characterized in that the protective gas comprises carbon dioxide in a proportion range from approximately 0.2 vol.-% to approximately 0.7 vol.-%, hydrogen in a proportion range from approximately 4.5 vol.-% to approximately 8 vol.-% and argon and/or helium in the remaining proportion range.

12. The method according to claim 11 wherein said proportion range of carbon dioxide in said protective gas is approximately 0.5 vol.-% to 0.6 vol.-%.

13. The method according to claim 11 wherein said proportion range of carbon dioxide in said protective gas is approximately 0.5 vol.

14. The method according to claim 11 wherein said proportion range of hydrogen in said protective gas is approximately 5 vol.-% to approximately 7 vol.-%.

15. The method according to claim 11 wherein said proportion range of hydrogen in said protective gas is approximately 6 vol.-%.

16. The method according to claim 1, characterized in that the protective gas is mixed at the processing point or at the usage location from two or more starting gases or starting gas mixtures.

17. The method according to claim 1, characterized in that the protective gas is sold and/or provided as a finished mixture.

18. The method according to claim 1, characterized in that at least one material bond of different types of material is provided, wherein at least one object selected from the group consisting of at least two different materials, made of at least two different types of materials, made of at least two different classes of material and made of at least one material from different batches is joined.

19. A use of at least one protective gas for electric arc joining using the method of Tungsten Inert Gas joining, wherein the protective gas comprises argon and/or helium, carbon dioxide in a proportion range from approximately 0.2 volume-percent (vol.-%) to approximately 0.7 vol.-%, and hydrogen in a proportion range from approximately 1.8 vol.-% to approximately 9 vol.-%.

20. The method according to claim 19 wherein said electric arc joining is selected from the group consisting of arc welding and arc soldering.

21. The method according to claim 19 wherein said tungsten inert gas joining is selected from the group consisting of tungsten inert gas welding and tungsten inert gas soldering.

22. The use according to claim 19, characterized in that the protective gas has hydrogen in a proportion range from approximately 4.5 vol.-% to approximately 8 vol.-%.

23. The method according to claim 19 wherein said proportion range of hydrogen in said protective gas is approximately 5 vol.-% to approximately 7 vol.-%.

24. The method according to claim 19 wherein said proportion range of hydrogen in said protective gas is approximately 6 vol.-%.

25. The use according to claim 19, characterized in that the protective gas has argon in a proportion range from approximately 30 vol.-% to approximately 95 vol.-% and/or helium in a proportion range from approximately 10 vol.-% to approximately 70 vol.-%.

26. The method according to claim 25 wherein said proportion range of argon in said protective gas is approximately 40 vol.-% to approximately 50 vol.-%.

27. The method according to claim 25 wherein said proportion range of helium in said protective gas is approximately 20 vol.-% to approximately 50 vol.-%.

28. The method according to claim 25 wherein said proportion range of helium in said protective gas is approximately 25 vol.-% to approximately 30 vol.-%.
